(19) United States
(12) Patent Application Publication
(10) Pub. No.: US 2026/0370446 A1
(43) Pub. Date: Nov. 19, 2026

(54) AUDIT DATA EARLY WARNING METHOD AND SYSTEM

(71) Applicant: HUANENG SHANTOU HAIMEN POWER GENERATION CO., LTD., Shantou (CN)

(72) Inventors: Liang YOU, Shantou (CN); Xiaojia ZHANG, Shantou (CN); Xiaochao YU, Shantou (CN); Xiaofeng LI, Shantou (CN); Mingguang CHEN, Shantou (CN); Jiehong JI, Shantou (CN); Lei ZHANG, Shantou (CN); Aifan YU, Shantou (CN)

(73) Assignee: HUANENG SHANTOU HAIMEN POWER GENERATION CO., LTD., Shantou (CN)

(21) Appl. No.: 19/661,669

(22) Filed: Apr. 28, 2026

(30) Foreign Application Priority Data
Apr. 28, 2025 (CN) CN202510549770.X

(51) Int. Cl. H04L 9/00; G06N 5/048

(52) U.S. Cl. CPC H04L 9/003; G06N 5/048; H04L 9/008

(57) ABSTRACT

Provided are an audit data early warning method and system. A raw data stream is generated by collecting node voltage and current of a power supply network as well as charge-discharge efficiency data of an energy storage system in real time through a distributed sensor network; local cleaning and standardized format conversion are performed by an edge computing node; dynamic risk assessment results and scheduling schemes are generated based on fuzzy logic reasoning and digital twin simulation; prediction deviations are analyzed via meta-learning, and closed-loop optimization is implemented by adopting model distillation technology. The system includes a distributed sensor network, an edge computing node, a multi-source data fusion module, and the like. The method and system improve the real-time performance of abnormality detection, the accuracy of risk assessment and the economic efficiency of energy storage scheduling of a power system.

### CROSS-REFERENCE TO RELATED APPLICATIONS

The present application claims priority to Chinese Patent Application No. 202510549770.X, filed on Apr. 28, 2025, the contents of which are incorporated herein by reference.

### TECHNICAL FIELD

The present disclosure belongs to the technical field of circuit devices or systems for power supply or distribution; electric energy storage systems, and in particular relates to intelligent data monitoring and abnormality early warning technology for power systems, and especially, to an audit data early warning method and system based on multi-source data fusion and intelligent analysis.

### BACKGROUND

With the expansion of the power system scale and the complication of the energy structure, the demand for data monitoring and abnormality early warning of a power network is increasing day by day. In a traditional power system, electric energy storage, power distribution control and power supply stability management highly rely on manual inspection or a simple alarm mechanism based on fixed thresholds, which is difficult to achieve real-time and dynamic abnormality detection and risk prediction. For example, in the prior art, there is a lack of active analysis capability for abnormal fluctuations of electric energy loss, equipment operating states or energy storage systems, resulting in delayed response to potential faults and affecting power supply reliability.

In addition, data monitoring of the existing power system mostly focuses on physical layer parameters (such as voltage and current), but lacks in-depth audit and correlation analysis capabilities for operating data. For example, how to construct a dynamic early warning model through fusion processing of multi-source data (such as load curves, energy storage efficiency, and power distribution node states) and realize intelligent identification of abnormal behaviors of the power system is still an urgent technical problem to be solved.

In view of this, there is an urgent need for an audit early warning method and system combining the characteristics of a power system and data intelligent analysis technology, so as to improve the efficiency of abnormality detection in power supply, power distribution and energy storage scenarios, and optimize the initiative and safety of electric energy management.

### SUMMARY

Aiming at the deficiencies of the prior art, the present disclosure provides an audit data early warning method and system to solve the problem of deficiencies of the prior art in the intelligent operation and maintenance of power systems.

To solve the above technical problem, the specific technical solutions of the present disclosure are set forth as follows:

In a first aspect, an audit data early warning method according to the present disclosure includes:
Step S101: collecting in real time, by a distributed sensor network, node voltage, current and load fluctuation data of a power supply network, and charge-discharge efficiency and capacity attenuation rate data of an electric energy storage system to generate a raw data stream;
Step S102: inputting the raw data stream into an edge computing node to perform local cleaning and standardized format conversion, to generate standardized intermediate data;
Step S103: performing cross-domain data fusion on the standardized intermediate data based on a federated learning framework and knowledge graph technology, extracting hidden features of topological relations of a power distribution network and dynamic correlation features between its charge-discharge behaviors and load fluctuations, and generating a correlation feature vector;
Step S104: performing dynamic feature engineering processing on the correlation feature vector by using self-supervised learning to generate multi-dimensional operation state features of a power system, performing abnormal pattern pre-screening on high-dimensional features through a lightweight abnormality detection model, and outputting a high-risk event pool;
Step S105: constructing a hierarchical early warning model based on the high-risk event pool, performing spatio-temporal feature modeling on time-series data of the power supply network by adopting a spatio-temporal fusion Transformer architecture to predict a device-level fault probability, and optimizing a load distribution and energy storage scheduling strategy of the power distribution network through a hybrid reinforcement learning framework to predict a system-level risk;
Step S106: generating a dynamic risk assessment level by combining fuzzy logic reasoning and evidence theory according to the device-level fault probability and a system-level risk prediction result, and triggering a real-time alarm or generating an energy storage scheduling suggestion and a load transfer scheme; and Step
S107: collecting system response data after execution of an early warning strategy, analyzing model prediction deviations through a meta-learning framework, and dynamically adjusting feature weights and a model structure to form a closed-loop optimization link;

where the raw data stream is transmitted to a data fusion module after being processed by the edge computing node, the correlation feature vector is input into the dynamic feature engineering module to generate a pre-screening result, the high-risk event pool drives training and decision-making of the hierarchical early warning model, and the risk assessment result is fed back reversely to a model optimization module.

Further, in the audit data early warning method of the present disclosure, said Step S103 includes:
extracting node vulnerability features in the topological relations of the power distribution network through a graph embedding algorithm, and capturing a nonlinear correlation between charge-discharge efficiency and load fluctuations based on a spatio-temporal attention mechanism;
performing federated learning alignment on structured data of a SCADA system and unstructured data of smart meters to generate a cross-domain correlated power operation knowledge graph; and
taking the hidden features and the dynamic correlation features as input to a dynamic feature engineering module, and forming a data closed loop for abnormal pattern pre-screening with an output of an abnormality detection model.

Further, in the audit data early warning method of the present disclosure, said Step S104 includes:
extracting harmonic distortion features from non-stationary time-series data by adopting wavelet transform, and performing data augmentation on abnormal samples through a generative adversarial network;
inputting augmented features into an improved Isolation Forest algorithm to perform rapid abnormality detection, and storing screened high-risk events into an event pool; and
taking the event pool as input to the hierarchical early warning model, and forming collaborative analysis of device-level and system-level risk assessment with spatio-temporal feature modeling of a spatio-temporal fusion Transformer.

Further, in the audit data early warning method of the present disclosure, said Step S105 includes:
introducing an interpretability module into a primary model, and locating a contribution degree of an abnormal feature through a SHAP value to assist in generating a device-level alarm instruction;
embedding a transfer learning module into a secondary model, and pre-training a strategy network by using historical power grid data to accelerate convergence of a load distribution strategy in new scenarios; and
inputting an output of the primary model and a strategy optimization result of the secondary model into a risk assessment module together to realize linkage of short-term fault response and medium-and long-term risk prevention and control.

Further, in the audit data early warning method of the present disclosure, said Step S106 includes:
adjusting an early warning threshold according to a real-time load state by adopting a sliding window statistical method, and simulating execution effect of the energy storage scheduling strategy in combination with a digital twin platform;
balancing power supply reliability and economic efficiency through a multi-objective optimization algorithm, generating the load transfer scheme, and pushing the load transfer scheme to an operation and maintenance terminal; and
taking a result of the simulation and an optimization strategy as input to an early warning execution module, and forming a tamper-proof instruction transmission link with a blockchain traceability mechanism.

Further, in the audit data early warning method of the present disclosure, said Step S107 includes:
constraining update of model weights in an incremental learning process through an elastic weight consolidation algorithm to prevent forgetting of historical knowledge;
transferring knowledge of a complex hybrid model to a lightweight network by using model distillation technology to adapt to real-time reasoning requirement of edge devices; and
inputting reversely the update of the model weights and a result of knowledge transfer into the feature engineering module to drive iterative optimization of dynamic feature generation and abnormality detection.

Further, in the audit data early warning method of the present disclosure, said performing federated learning alignment on structured data of a SCADA system and unstructured data of smart meters to generate a cross-domain correlated power operation knowledge graph includes:
adopting the differential privacy technology to protect data security of each power subsystem in a data fusion process, and realizing cross-domain feature sharing through gradient encrypted transmission; and
inputting topological relation features of the knowledge graph and data after the federated learning alignment into the spatio-temporal attention mechanism together to enhance robustness of correlation analysis between the charge-discharge behaviors and the load fluctuations.

Further, in the audit data early warning method of the present disclosure, said performing data augmentation on abnormal samples through a generative adversarial network includes a generator and a discriminator, and where the generator is configured to inject adversarial perturbations simulating sensor noise into input data, and the discriminator focuses on classification training of high-risk samples through a Focal Loss function;
injecting the adversarial perturbations simulating sensor noise into the input data, and focusing on the classification training of high-risk samples through the Focal Loss function; and
forming a high-precision pre-screening result by a feature vector after adversarial training and an output of the lightweight abnormality detection model to reduce a false alarm rate of the hierarchical early warning model.

Further, in the audit data early warning method of the present disclosure, said embedding a transfer learning module into a secondary model, and pre-training a strategy network by using historical power grid data to accelerate convergence of a load distribution strategy in new scenarios includes:
initializing reinforcement learning network parameters by using a pre-trained power distribution network load distribution strategy, and dynamically adjusting energy storage scheduling actions through a proximal policy optimization algorithm; and
driving strategy simulation of the digital twin platform by a collaborative output of transfer learning and reinforcement learning to form a closed-loop verification link from model training to actual execution.

In a second aspect, an audit data early warning system according to the present disclosure is applied to the audit data early warning method and includes:
a distributed sensor network configured to collect in real time node voltage and current of the power supply network and charge-discharge efficiency data of the electric energy storage system;
an edge computing node connected with the sensor network and configured to perform local cleaning and standardized processing on raw data to generate the standardized intermediate data;
a multi-source data fusion module connected with the edge computing node and configured to extract cross-domain correlated features through federated learning and knowledge graph technology;
a dynamic feature engineering module connected with the multi-source data fusion module and configured to generate the multi-dimensional operation state features and perform the abnormal pattern pre-screening;
a hierarchical early warning model construction module connected with the dynamic feature engineering module and configured to train the spatio-temporal fusion Transformer and the hybrid reinforcement learning framework;
a risk assessment and decision-making module connected with the hierarchical early warning model construction module and configured to generate a dynamic risk level and the energy storage scheduling strategy; and
a closed-loop optimization module connected with the risk assessment and decision-making module and configured to realize adaptive updating of the early warning model through meta-learning and model distillation technology;
where data of the sensor network is transmitted to the edge computing node, the standardized intermediate data is input to the dynamic feature engineering module after being processed by the multi-source data fusion module, an output of the hierarchical early warning model drives risk assessment and decision-making, and a decision-making result is fed back reversely to the closed-loop optimization module.

### Advantageous effects of the disclosure

In the audit data early warning method and system according to the present disclosure, the multi-source heterogeneous data of the power supply network and the electric energy storage system is collected in real time through the distributed sensor network, and local cleaning and standardized processing are performed in combination with the edge computing node, thereby effectively reducing data transmission delay and improving data quality; cross-domain data fusion is implemented based on the federated learning framework and the knowledge graph technology, the hidden features of the topological relations of the power distribution network and the dynamic correlation features between its charge-discharge behaviors and load fluctuations are extracted on the premise of protecting data privacy of each subsystem, so as to enhance semantic correlation analysis capability of multi-modal data; dynamic feature engineering processing is performed on the correlation features by using the self-supervised learning, harmonic distortion features of non-stationary time-series data are extracted through the wavelet transform, and abnormal sample distribution is enhanced in combination with the generative adversarial network, so as to improve recognition sensitivity of the lightweight abnormality detection model to concealed faults; the spatio-temporal dependence of the time-series data of the power supply network is modeled by adopting the spatio-temporal fusion Transformer architecture, the device-level fault probability is accurately predicted, the load distribution and energy storage scheduling strategy of the power distribution network is optimized through the hybrid reinforcement learning framework, the execution effect of the strategy is simulated in combination with the digital twin platform, so as to realize collaborative optimization of device-level short-time response and system-level medium-and-long-term risk prevention and control; the closed-loop optimization link is constructed based on the meta-learning framework and the elastic weight consolidation algorithm, the feature weights and the model structure are dynamically adjusted, the real-time inference requirement of the edge devices is adapted in combination with the model distillation technology, so as to form an early warning model iteration mechanism adaptive to the dynamic operation environment of the power system, thereby improving real-time performance of abnormality detection of the power supply network, accuracy of risk assessment and economic efficiency of energy storage scheduling, which meets the technical requirements of intelligent monitoring and energy storage management of power system under the H02J classification.

### BRIEF DESCRIPTION OF THE DRAWINGS

To more clearly illustrate the technical solutions of the present disclosure, the accompanying drawings required in the embodiments will be briefly introduced below. Apparently, those of ordinary skill in the art can also obtain other accompanying drawings from these drawings without creative efforts.

FIG. 1 is a flowchart of an audit data early warning method according to an embodiment of the present disclosure.

### DETAILED DESCRIPTION OF THE EMBODIMENTS

To make the objectives, technical solutions and advantages of the present disclosure clearer, the technical solutions of the present disclosure will be clearly and completely described below in conjunction with the specific embodiments of the present disclosure and the corresponding accompanying drawings. Apparently, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure. The technical solutions provided by the various embodiments of the present disclosure will be illustrated in detail below with reference to the accompanying drawings. To better understand the objectives of the present disclosure, the present disclosure will be described in further detail below.

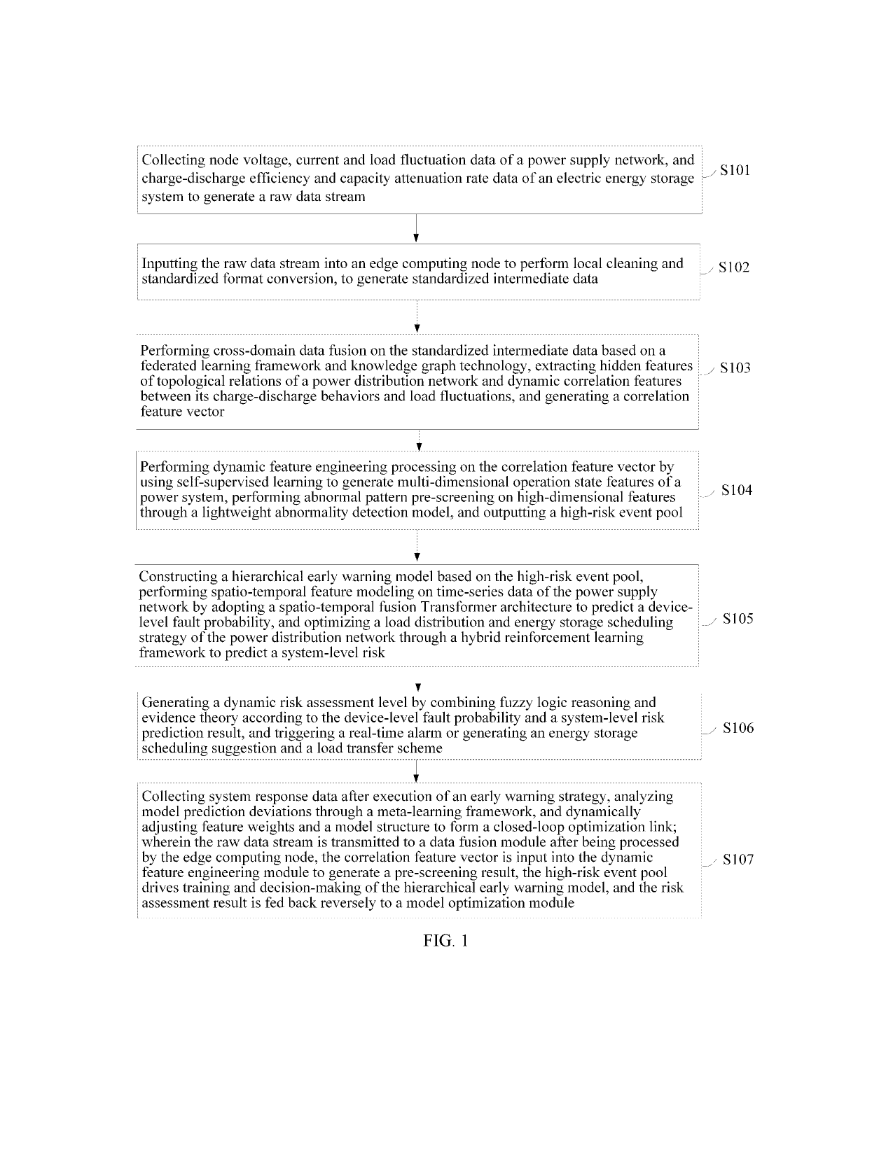

With reference to FIG. 1, in a first aspect, an audit data early warning method according to the present disclosure includes:
Step S101: collecting in real time, by a distributed sensor network, node voltage, current and load fluctuation data of a power supply network, and charge-discharge efficiency and capacity attenuation rate data of an electric energy storage system to generate a raw data stream;
Step S102: inputting the raw data stream into an edge computing node to perform local cleaning and standardized format conversion, to generate standardized intermediate data;
Step S103: performing cross-domain data fusion on the standardized intermediate data based on a hierarchical federated learning framework and knowledge graph technology, extracting node vulnerability features in topological relations of a power distribution network through a graph embedding algorithm, capturing a nonlinear correlation between charge-discharge efficiency and load fluctuations based on a spatio-temporal attention mechanism, and generating a correlation feature vector;
Step S104: performing dynamic feature engineering processing on the correlation feature vector by using self-supervised learning to generate multi-dimensional operation state features of a power system, performing abnormal pattern pre-screening on high-dimensional features through a lightweight abnormality detection model, and outputting a high-risk event pool;
Step S105: constructing a hierarchical early warning model based on the high-risk event pool, performing spatio-temporal feature modeling on time-series data of the power supply network by adopting a spatio-temporal fusion Transformer architecture to predict a device-level fault probability, and optimizing a load distribution and energy storage scheduling strategy of the power distribution network through a hybrid reinforcement learning framework to predict a system-level risk;
Step S106: generating a dynamic risk assessment level by combining fuzzy logic reasoning and evidence theory according to the device-level fault probability and a system-level risk prediction result, and triggering a real-time alarm or generating an energy storage scheduling suggestion and a load transfer scheme; and
Step S107: collecting system response data after execution of an early warning strategy, analyzing model prediction deviations through a meta-learning framework, and dynamically adjusting feature weights and a model structure to form a closed-loop optimization link;

where the raw data stream is transmitted to a data fusion module after being processed by the edge computing node, the correlation feature vector is input into the dynamic feature engineering module to generate a pre-screening result, the high-risk event pool drives training and decision-making of the hierarchical early warning model, and the risk assessment result is fed back reversely to a model optimization module.

In Step S101, the distributed sensor network is deployed at key power distribution nodes of the power supply network and battery cluster monitoring points of the electric energy storage system, and specifically includes high-precision voltage transformers, Hall current sensors, and battery state-of-health monitoring units. The edge computing node adopts a sliding window filtering algorithm for the collected raw voltage and current signals to eliminate high-frequency noise interference, and compensates for time-series data missing caused by communication delay through linear interpolation. For the capacity attenuation rate data of the electric energy storage system, a Kalman filtering-based state estimation algorithm is adopted to correct sensor drift errors, so as to generate the raw data stream with a time synchronization mark. A data encapsulation module converts multi-source heterogeneous data into a standardized JSON format including a device identifier, a normalized value, and a data quality identification field, so as to provide structured input for subsequent processing.

A hierarchical processing strategy is adopted in the local cleaning process of Step S102: performing interquartile range-based outlier detection and replacement on continuous data such as voltage and current; implementing redundant node elimination and adjacency matrix reconstruction on power distribution network topology state data; and applying sliding average smoothing processing on charge-discharge efficiency data of the energy storage system. A standardization module uniformly converts data of different dimensions into an interval [-1, 1], where time-series data are aligned in terms of sampling frequency through a dynamic time warping algorithm, and unstructured data are converted into a graph structure representation. The edge node pushes the standardized intermediate data to a cloud message queue through an MQTT protocol, and attaches a data traceability tracking label to support full-process audit and traceability.

The cross-domain data fusion in Step S103 adopts the hierarchical federated learning framework, and integrates real-time monitoring data of a SCADA system and user load curves of smart meters on the premise of protecting data privacy. A graph embedding module performs unsupervised learning on the power distribution network topology by using a GraphSAGE algorithm, so as to extract low-dimensional vectors characterizing electrical characteristics of nodes and regional power supply correlation. The spatio-temporal attention mechanism calculates a dynamic correlation matrix between charge-discharge power sequences of the energy storage system and regional load curves, so as to identify potential overload risk propagation paths. A knowledge graph construction module fuses the topological feature vectors, the spatio-temporal correlation matrix and equipment metadata to generate a power operation knowledge graph including entity relationship weights and event causal chains, so as to provide multi-dimensional correlation input for feature engineering.

The dynamic feature engineering in Step S104 implements a three-level processing flow: multi-resolution analysis is performed on non-stationary time-series data through a wavelet packet transform to extract energy entropy of each frequency band as a harmonic distortion feature; a conditional generative adversarial network is adopted to perform feature space expansion on historical abnormal samples to balance the distribution of positive and negative samples; and an improved Isolation Forest model introduces information gain to optimize a feature splitting criterion, so as to improve detection sensitivity to hidden fault patterns. A pre-screening module dynamically divides a risk level threshold according to an abnormal score, stores events exceeding an adaptive threshold into a priority queue, and triggers an incremental training task of a hierarchical early warning model.

The hierarchical early warning model in Step S105 adopts a dual-channel collaborative architecture: a short-term risk prediction channel deploys a spatio-temporal fusion Transformer model, captures spatio-temporal dependence of voltage and current sequences through a multi-head self-attention mechanism, and uses an interpretability module to calculate feature contribution weights to locate abnormal root cause equipment; and a medium and long-term risk prediction channel combines a deep deterministic policy gradient algorithm and proximal policy optimization to construct a multi-objective optimization strategy constrained by load balance and energy storage life loss. A transfer learning module uses model parameters pre-trained on other regional power grids as an initialization benchmark, and aligns feature distribution differences through a domain adaptation algorithm to accelerate strategy convergence efficiency in new scenarios.

The dynamic risk assessment in Step S106 introduces a fuzzy Petri net model to map device-level fault probability and system-level risk indicators into a comprehensive risk level and generate a multi-objective optimization strategy. A digital twin platform constructs a virtual mirror image based on real-time topological state, simulates the influence of a load transfer scheme on power supply reliability, and outputs an optimal execution path. A blockchain smart contract adds a timestamp and a digital signature to generated scheduling instructions, verifies instruction integrity through a decentralized node consensus mechanism, and forms a tamper-proof audit tracking link to ensure trusted execution of the scheduling instructions.

The closed-loop optimization module in Step S107 designs a two-level feedback mechanism: local feedback adopts an elastic weight consolidation algorithm to calculate a Fisher information matrix of model parameters with respect to historical tasks, constrain a weight update amplitude in an incremental learning process, and prevent model forgetting of historical knowledge; and global feedback analyzes statistical characteristics of multi-batch prediction deviations through a meta-learning framework, and dynamically adjusts feature selection weights and model hyperparameter configurations. A model distillation module transfers knowledge of a complex early warning model to a lightweight TinyLSTM network, and adopts a temperature scaling strategy to soften an output probability distribution, so as to adapt to low-latency inference requirements of edge devices. The optimized model parameters are used to replace an old version in phases through a canary release strategy, so as to maintain high availability and stability of an early warning system.

Specifically, in the audit data early warning method of the present disclosure, said Step S103 includes:
extracting node vulnerability features in the topological relations of the power distribution network through a graph embedding algorithm, and capturing a nonlinear correlation between charge-discharge efficiency and load fluctuations based on a spatio-temporal attention mechanism;
through differential privacy technology and a Paillier homomorphic encryption algorithm, performing federated learning alignment on structured data of a SCADA system and unstructured data of smart meters to generate a cross-domain correlated power operation knowledge graph containing device states, load distribution and topological relations; and
taking the hidden features and the dynamic correlation features as input to a dynamic feature engineering module, and forming a data closed loop for abnormal pattern pre-screening with an output of an abnormality detection model.

In the cross-domain data fusion process, the graph embedding algorithm adopts an unsupervised GraphSAGE learning framework to perform hierarchical aggregation on an adjacency matrix and node attribute data of the power distribution network topology, extract low-dimensional vectors characterizing electrical load rate, power supply radius and connectivity of nodes, and quantitatively evaluate vulnerability indicators of each node. The spatio-temporal attention mechanism calculates a dynamic correlation coefficient matrix between charge-discharge efficiency sequences of the energy storage system and regional load fluctuation curves through a multi-head self-attention layer, identifies response delay characteristics of charge-discharge behavior to load sudden changes, and constructs a charge-discharge-load correlation weight map. The hierarchical federated learning framework introduces the differential privacy technology to perform encrypted alignment on structured monitoring data of the SCADA system and unstructured load curves of smart meters, adopts a homomorphic encryption algorithm to realize cross-domain gradient sharing, and generates the power operation knowledge graph including device states, load distribution and topological relations, where an edge weight of an entity relationship is jointly calculated by the node vulnerability vector and the spatio-temporal correlation matrix.

The knowledge graph construction module performs tensor fusion on the node vulnerability feature vectors output by the graph embedding algorithm and the dynamic correlation matrix generated by the spatio-temporal attention mechanism, iteratively updates entity relationship weights through a graph convolutional network, and forms multi-dimensional correlation features including health states of power supply devices, regional load correlation modes and energy storage response characteristics. The fused feature data is processed by standardization to generate correlation feature vectors of a unified dimension, which are input into the dynamic feature engineering module for abnormal pattern analysis. Meanwhile, high-risk events output by the abnormality detection model are fed back to the knowledge graph updating module to trigger dynamic correction of the entity relationship weights, so as to form a closed-loop optimization link between cross-domain data fusion and abnormality detection.

Specifically, in the audit data early warning method of the present disclosure, said Step S104 includes:
extracting harmonic distortion features from non-stationary time-series data by adopting wavelet transform, and performing data augmentation on abnormal samples through a generative adversarial network;
inputting augmented features into an improved Isolation Forest algorithm that optimizes a feature splitting criterion by adapting information gain to perform rapid abnormality detection, and storing screened high-risk events into an event pool; and
taking the event pool as input to the hierarchical early warning model, and forming collaborative analysis of device-level and system-level risk assessment with spatio-temporal feature modeling of a spatio-temporal fusion Transformer.

In the dynamic feature engineering process, a wavelet transform module adopts a discrete wavelet packet decomposition algorithm to perform multi-scale decomposition on non-stationary time-series data such as voltage and current, selects a Daubechies wavelet basis function to reconstruct high-frequency subbands, and calculates energy entropy of each subband as a quantitative indicator for harmonic distortion features. A generator of the generative adversarial network adopts a multi-layer perceptron structure, inputs feature vectors of historical abnormal events and equipment type labels, and generates synthetic abnormal samples with diverse distributions; a discriminator introduces a conditional convolution layer, verifies the rationality of generated samples in combination with equipment operation state labels, and optimizes alignment of feature distributions between the generated samples and real abnormal samples through adversarial training. A data-augmented feature set is input into the improved Isolation Forest model, which adopts information gain to optimize the feature splitting criterion and selects feature dimensions with the highest discrimination for spatial partitioning, so as to improve detection sensitivity to low-probability abnormal events.

The abnormality detection model calculates an abnormal score according to a path length of a sample in an isolation tree, dynamically adjusts a threshold interval in combination with a sliding window statistical method, and marks events with scores higher than the adaptive threshold as high-risk events. The event pool adopts a priority queue structure to store events hierarchically according to risk levels and time urgency, and high-priority events trigger real-time alarms and are pushed to the hierarchical early warning model. The spatio-temporal fusion Transformer model receives high-risk event features from the event pool, captures spatio-temporal correlation patterns of voltage and current sequences through the multi-head self-attention mechanism, and generates device-level fault probability prediction results; meanwhile, a reinforcement learning module dynamically adjusts a load distribution strategy of the power distribution network based on system-level risk features in the event pool, optimizes charge-discharge scheduling instructions of the electric energy storage system, and forms a collaborative analysis link between equipment abnormality location and system strategy adjustment.

A data flow and a model collaboration mechanism of the event pool form a closed-loop feedback: fault location information output by the spatio-temporal fusion Transformer reversely modifies a feature extraction frequency band selection strategy of the wavelet transform; strategy optimization results of the reinforcement learning module synchronously update equipment state condition inputs of the generative adversarial network, driving a data augmentation module to focus on generation of abnormal features of weak links of the current system. The dynamic feature engineering module and the hierarchical early warning model realize bidirectional interaction of data and strategies through the event pool, enhancing the joint perception capability for multi-dimensional operation risks of the power system.

Specifically, in the audit data early warning method of the present disclosure, said Step S105 includes:
introducing an interpretability module into a primary model, and locating a contribution degree of an abnormal feature through a SHAP value to assist in generating a device-level alarm instruction;
embedding a transfer learning module into a secondary model, and pre-training a strategy network by using historical power grid data to accelerate convergence of a load distribution strategy in new scenarios; and
inputting an output of the primary model and a strategy optimization result of the secondary model into a risk assessment module together to realize linkage of short-term fault response and medium-and long-term risk prevention and control.

In the construction of the hierarchical early warning model, the interpretability module of the primary model adopts a kernel function-based approximate calculation method for SHAP values to perform feature attribution analysis on device-level fault probabilities output by the spatio-temporal fusion Transformer. By calculating the marginal contribution degree of each voltage and current time-series feature to the abnormal score, a feature importance ranking list is generated, and a visualized diagnosis report is generated in combination with the topological relation of the power distribution network. An alarm instruction generation module dynamically screens key abnormal indicators according to a feature contribution degree threshold, matches a preset equipment fault knowledge base, generates a structured alarm instruction containing location information and maintenance suggestions, and pushes the structured alarm instruction to an operation and maintenance terminal.

The transfer learning module of the secondary model adopts a pre-training and fine-tuning architecture: a deep reinforcement learning strategy network is trained on historical power grid data to learn a global optimization mode of load distribution and energy storage scheduling; the domain adaptation algorithm is adopted to align feature distribution differences between new and old scenarios, and a maximum mean difference metric is adopted to adjust the hidden layer parameters of the strategy network. A curriculum learning strategy is introduced in a fine-tuning stage to gradually increase a training weight of new scenario data, so as to accelerate the convergence speed of the strategy network in a target region. The optimized load distribution strategy outputs a dynamic scheduling instruction set including a power distribution line load threshold adjustment parameter and a charge-discharge power suggestion for the energy storage system.

The device-level alarm instruction from the primary model and the system-level scheduling instruction from the secondary model are jointly input into the risk assessment module, and the fuzzy Petri net is adopted to construct a multi-level risk inference engine. The device fault probability is input as a place node, the system strategy optimization result is taken as a transition trigger condition, and a comprehensive risk level index is calculated through a fuzzy rule base. A risk linkage module triggers a hierarchical response according to an index threshold: a low-risk event triggers equipment state tracking and monitoring; a medium-high risk event synchronously starts simulation of the load transfer scheme and pre-adjustment of the energy storage system, and an execution instruction is generated after strategy feasibility is verified through the digital twin platform. The cooperative outputs of the two-level models are encapsulated through the blockchain smart contract, and a timestamp and an equipment signature are attached to form the audit tracking chain, so as to realize the data closed loop of short-term fault disposal and medium-and long-term strategy optimization.

Specifically, in the audit data early warning method of the present disclosure, said Step S106 includes:
adjusting an early warning threshold according to a real-time load state by adopting a sliding window statistical method, and simulating execution effect of the energy storage scheduling strategy in combination with a digital twin platform;
balancing power supply reliability and economic efficiency through a multi-objective optimization algorithm, generating the load transfer scheme, and pushing the load transfer scheme to an operation and maintenance terminal; and
taking a result of the simulation and an optimization strategy as input to an early warning execution module, and forming a tamper-proof instruction transmission link with a blockchain traceability mechanism.

In the dynamic risk assessment process, a sliding window statistics module calculates a regional load mean value and variance in real time according to a preset time window length, and dynamically adjusts a device-level early warning threshold interval in combination with the topological state of the power supply network. The window length is adaptively adjusted based on a load fluctuation period, where a short window is adopted in a peak period to capture rapid changes, and a long window is used in a valley period to smooth noise. The digital twin platform constructs the virtual mirror image of the power supply network, injects real-time topological data and state parameters of the energy storage system, simulates the influences of different charge-discharge strategies on node voltage stability and line loss through a discrete event simulation engine, and outputs a load balance degree change curve and an equipment life attenuation prediction value after strategy execution.

A multi-objective optimization module adopts an NSGA-III algorithm to perform Pareto frontier solution on power supply reliability, economic efficiency and energy storage life loss, so as to generate an optimal solution set of the load transfer scheme. An optimization model inputs the simulation result of the digital twin as a constraint condition, generates candidate strategies through crossover and mutation operations of a genetic algorithm, calculates a weight of each objective through an entropy weight method, and screens the scheme with the highest comprehensive score. The generated load transfer instruction includes a target line switching sequence and an energy storage output adjustment parameter, and is pushed to an instruction execution queue of the operation and maintenance terminal after format standardization.

The blockchain traceability mechanism performs hash digest calculation on the simulation result and the optimization strategy, generates a unique data fingerprint and writes the unique data fingerprint into a distributed ledger. The instruction transmission link adopts an asymmetric encryption algorithm to sign the load transfer scheme, and verifies identity permissions and data integrity of execution nodes through the smart contract. The early warning execution module monitors an instruction execution state in real time after strategy issuance, feeds the actual load transfer effect back to the digital twin platform for effect verification, so as to form a closed-loop verification link of simulation-execution-feedback. The dynamically adjusted early warning threshold and the optimization strategy realize version traceability through the timestamp sequence of the blockchain, supporting full life cycle audit and backtracking.

Specifically, in the audit data early warning method of the present disclosure, said Step S107 includes:
constraining update of model weights in an incremental learning process through an elastic weight consolidation algorithm to prevent forgetting of historical knowledge;
transferring knowledge of a complex hybrid model to a lightweight network by using model distillation technology to adapt to real-time reasoning requirement of edge devices; and
inputting reversely the update of the model weights and a result of knowledge transfer into the feature engineering module to drive iterative optimization of dynamic feature generation and abnormality detection.

In the closed-loop optimization link, the elastic weight consolidation algorithm calculates the Fisher information matrix of the model parameters in historical training tasks, identifies the weight parameters with high importance to learned knowledge, introduces a regularization constraint term in the incremental learning process, and limits the update amplitude of the key weights. The incremental learning module dynamically adjusts constraint intensity according to the newly arrived power system operation data, adopts an adaptive learning rate strategy to balance learning weights of old and new knowledge, and maintains the memory capability of the model for the historical abnormal patterns.

The model distillation technology adopts the temperature scaling strategy to smooth the output probability distribution of the complex hybrid model, and generates soft target labels rich in decision logic. The lightweight network fits the joint distribution of soft targets and real labels through the multi-layer perceptron structure, optimizes the network parameters by adopting a knowledge distillation loss function, and reduces the model complexity. The distilled lightweight network is deployed at the edge computing node, parses a sensor data stream in real time and outputs a preliminary abnormality detection result, so as to reduce communication latency of cloud model inference.

The feature engineering module receives the model parameters updated by the elastic weight consolidation algorithm and the abnormality detection results output by the distilled network, and dynamically adjusts the frequency band selection strategy of the wavelet transform and the sample generation weight of the generative adversarial network. The feature selection module optimizes the combination mode of multi-dimensional features according to the weight importance ranking fed back by the model, so as to improve the accuracy of abnormal pattern recognition. The updated feature generation strategy is re-input into the incremental learning module for model fine-tuning, so as to form a bidirectional collaboration mechanism of feature optimization and model update, and enhance the adaptive capability of the early warning system for the dynamic operation environment of the power system.

Specifically, in the audit data early warning method of the present disclosure, said performing federated learning alignment on structured data of a SCADA system and unstructured data of smart meters to generate a cross-domain correlated power operation knowledge graph includes:
adopting the differential privacy technology to protect data security of each power subsystem in a data fusion process, and performing encrypted transmission on gradients through the Paillier homomorphic encryption algorithm to realize cross-domain feature sharing; and
inputting topological relation features of the knowledge graph and data after the federated learning alignment into the spatio-temporal attention mechanism together to enhance robustness of correlation analysis between the charge-discharge behaviors and the load fluctuations.

In the implementation of the federated learning framework, each power subsystem, as a participant, locally trains a feature extraction model, and adopts a Laplace mechanism to add random noise satisfying a differential privacy condition to model gradients, so as to protect privacy of raw data. A central aggregation server performs weighted averaging on encrypted gradients of all participants through a secure multi-party computation protocol, and generates global model update parameters. The Paillier homomorphic encryption algorithm is adopted in a gradient transmission process, such that gradient ciphertexts uploaded by participants can be directly subjected to mathematical operations in an aggregation stage, thereby avoiding a data leakage risk in a decryption link.

The knowledge graph construction module receives cross-domain data after federated learning alignment, performs neighborhood feature aggregation on topological nodes of the power distribution network through a graph attention network, and generates topological relation vectors characterizing regional power supply correlation strength. The spatio-temporal attention mechanism performs tensor concatenation on the topological relation vectors and charge-discharge efficiency features extracted by federated learning, and adopts the multi-head self-attention layer to calculate the dynamic correlation matrix between charge-discharge power sequences and load fluctuation curves at different time scales. An attention weight matrix is normalized through Softmax to generate a spatio-temporal correlation graph, revealing a causal link between energy storage response delay and load mutation events, and improving robustness of abnormal correlation pattern mining.

The collaborative effect of the federated learning framework and the knowledge graph forms a two-way data flow: the global model parameter update of federated learning drives the dynamic optimization of topological relation vectors of the knowledge graph; and spatio-temporal correlation features output by the knowledge graph reversely guide the design of a local training objective function of federated learning participants, enhancing the focusing capability of the feature extraction module on key correlation patterns. Fusion processing of encrypted gradients and topological features is realized through an edge-cloud collaborative architecture, edge nodes execute local model reasoning and privacy protection processing, and a cloud center completes cross-domain feature fusion and correlation analysis, constructing a secure and credible distributed audit early warning architecture.

Specifically, in the audit data early warning method of the present disclosure, said performing data augmentation on abnormal samples through a generative adversarial network includes a generator and a discriminator, and where the generator is configured to inject adversarial perturbations simulating sensor noise into input data, and the discriminator focuses on classification training of high-risk samples through a Focal Loss function;
injecting the adversarial perturbations simulating sensor noise into the input data, and focusing on the classification training of high-risk samples through the Focal Loss function; and
forming a high-precision pre-screening result by a feature vector after adversarial training and an output of the lightweight abnormality detection model to reduce a false alarm rate of the hierarchical early warning model.

In the implementation of the generative adversarial network, the generator module adopts a conditional generative adversarial architecture, inputs equipment type labels and normal state feature vectors, and generates synthetic data injected with the simulated sensor noise. The adversarial perturbations are modeled based on a historical sensor error distribution, a noise sequence with spatio-temporal correlation is generated through a Gaussian mixture model, and the noise sequence is superimposed on original voltage and current signals to simulate signal distortion in a real acquisition environment. The discriminator module adopts a deep convolutional network structure, stabilizes a training process in combination with spectral normalization technology, and distinguishes distribution differences between real data and synthetic data through multi-layer feature extraction.

The Focal Loss function introduces a dynamic adjustment mechanism in classifier training, dynamically calculates a weight factor according to prediction confidence of abnormal samples, and increases a loss contribution proportion of high-risk samples. The classifier adopts a twin-tower structure network, respectively processes feature vectors generated by adversarial training and original feature vectors, and aligns feature space distribution through contrastive learning. A hard sample mining strategy is adopted in a training process to perform iterative resampling on misclassified high-risk samples, so as to improve discrimination of a classification boundary.

The lightweight abnormality detection model adopts the model distillation technology, and transfers decision logic of a deep classifier after adversarial training to a TinyLSTM lightweight network. A temperature parameter is adopted to adjust and soften a classification probability distribution in a distillation process, and a KL divergence loss function is adopted to align output distribution features of a teacher model and a student model. An abnormal probability score output by the lightweight model and the adversarial training feature vector are subjected to weighted fusion to generate a comprehensive abnormal index, and instantaneous false alarms are eliminated through sliding window mean filtering before the comprehensive abnormal index is input into the hierarchical early warning model.

Collaborative training of the generative adversarial network and the lightweight model forms a dynamic optimization closed loop: a false alarm detection result of the lightweight model is fed back to the generator module, triggering iterative optimization of an adversarial noise pattern; and high-risk sample distribution features output by the classifier synchronously update a weight adjustment strategy of the Focal Loss, so as to enhance adaptability to new abnormal patterns. The feature fusion module associates and stores the optimized comprehensive abnormal index with the equipment operation state labels, constructs a dynamically updated abnormal pattern knowledge base, and supports continuous identification of new and old fault types by the early warning model.

Specifically, in the audit data early warning method of the present disclosure, said embedding a transfer learning module into a secondary model, and pre-training a strategy network by using historical power grid data to accelerate convergence of a load distribution strategy in new scenarios includes:
initializing reinforcement learning network parameters by using a pre-trained power distribution network load distribution strategy, and dynamically adjusting energy storage scheduling actions through a proximal policy optimization algorithm; and
driving strategy simulation of the digital twin platform by a collaborative output of transfer learning and reinforcement learning to form a closed-loop verification link from model training to actual execution.

In the implementation of the transfer learning module, a pre-training stage adopts load distribution data and equipment operation logs of a historical power distribution network to train a deep neural network, so as to learn load balancing allocation modes under different topological structures. Parameters of the strategy network of the reinforcement learning network take weights of the pre-trained model as initial values, align feature distribution differences of node voltage and line impedance between new and old scenarios through the domain adaptation algorithm, and adjust a hidden layer feature mapping relationship by adopting a maximum mean difference loss function. The proximal policy optimization algorithm introduces a trust region constraint in an action selection process, limits a policy update step size to maintain training stability, evaluates long-term benefits of energy storage charge and discharge actions by using a generalized advantage function, and dynamically adjusts charge and discharge power thresholds and response priorities.

The digital twin platform constructs the virtual mirror image of the power distribution network, imports real-time topological data and state of charge (SOC) parameters of the energy storage system, and simulates node voltage fluctuation and line loss change under the scheduling strategies through the discrete event simulation engine. The simulation results are subjected to feasibility comparison with the scheduling instructions output by the reinforcement learning to screen a candidate strategy set satisfying the power supply reliability constraints. The curriculum learning module dynamically adjusts the training data distribution according to the strategy execution difficulty, preferentially learns historical scenario data with high matching degree with the current system state, and accelerates the convergence speed of the strategy network in the target region.

The collaborative effect of the transfer learning and the reinforcement learning is realized through the closed-loop verification link: load distribution knowledge of the pre-trained model drives initial strategy generation of the digital twin platform; the optimized strategy after simulation verification iteratively updates the network parameters through the proximal policy optimization algorithm; and the output of the updated strategy network synchronously corrects parameters of the domain adaptation module of the pre-trained model. The blockchain smart contract adds equipment digital signatures and timestamps to the verified scheduling instructions, generates the tamper-proof audit tracking records, and forms a trusted control link from virtual simulation to physical execution.

In a second aspect, an audit data early warning system according to the present disclosure is applied to the audit data early warning method and includes:
a distributed sensor network configured to collect in real time node voltage and current of the power supply network and charge-discharge efficiency data of the electric energy storage system;
an edge computing node connected with the sensor network and configured to perform local cleaning and standardized processing on raw data to generate the standardized intermediate data;
a multi-source data fusion module connected with the edge computing node and configured to extract cross-domain correlated features through federated learning and knowledge graph technology;
a dynamic feature engineering module connected with the multi-source data fusion module and configured to generate the multi-dimensional operation state features and perform the abnormal pattern pre-screening;
a hierarchical early warning model construction module connected with the dynamic feature engineering module and configured to train the spatio-temporal fusion Transformer and the hybrid reinforcement learning framework;
a risk assessment and decision-making module connected with the hierarchical early warning model construction module and configured to generate a dynamic risk level and the energy storage scheduling strategy; and
a closed-loop optimization module connected with the risk assessment and decision-making module and configured to realize adaptive updating of the early warning model through meta-learning and model distillation technology;
where data of the sensor network is transmitted to the edge computing node, the standardized intermediate data is input to the dynamic feature engineering module after being processed by the multi-source data fusion module, an output of the hierarchical early warning model drives risk assessment and decision-making, and a decision-making result is fed back reversely to the closed-loop optimization module.

The distributed sensor network is deployed at power distribution transformers, line section switches of the power supply network, and battery cluster monitoring points of the energy storage system, and includes Hall current sensors, voltage transformers, and wireless temperature sensors. Sensor nodes transmit data via a low-power wide-area network protocol, perform sliding window filtering on high-sampling-rate current signals, and eliminate high-frequency electromagnetic interference noise. The edge computing node incorporates an outlier detection algorithm, establishes a voltage fluctuation confidence interval based on historical data distribution, and performs linear interpolation compensation on raw data exceeding a threshold. The data encapsulation module converts multi-source heterogeneous data into a standardized JSON format, adds device geographic tags and time synchronization identifiers, and transmits the data to an edge node message queue through the MQTT protocol.

A local cleaning module of the edge computing node adopts a moving average algorithm to smooth load fluctuation data, and performs missing value filling based on a Gaussian process on charge-discharge efficiency data of the energy storage system. The standardized processing module performs dynamic range compression on voltage and current time-series data and maps values to the interval [-1, 1]; and unstructured topological data is converted into an adjacency matrix and a node attribute table. The time alignment module adopts a dynamic time warping algorithm to unify the sampling frequency of multi-source data, and generates an intermediate data set with a unified time index. The data version management module attaches a timestamp and a hash check code to the intermediate data to support incremental update and version backtracking.

The federated learning framework of the multi-source data fusion module adopts a hierarchical architecture, establishes an encrypted communication channel between the SCADA system and the smart meter data source, and realizes cross-domain gradient aggregation through a homomorphic encryption algorithm. The knowledge graph construction module applies a GraphSAGE algorithm to perform unsupervised learning on the topology of the power distribution network to generate low-dimensional vectors characterizing power supply capacity of nodes and regional correlation. The spatio-temporal attention mechanism calculates a dynamic correlation matrix of a charge-discharge power sequence of the energy storage system and a regional load curve, and identifies a lag effect of load mutations on energy storage responses. The fused cross-domain feature vector is attached with a device state tag and input to the dynamic feature engineering module for abnormal pattern mining.

The wavelet transform unit of the dynamic feature engineering module adopts a DB4 wavelet basis to perform multi-scale decomposition on voltage harmonic data, and extracts energy entropy of each sub-band as a harmonic distortion feature. A generator module of a generative adversarial network generates adversarial samples based on device type tags, and a discriminator adopts a spectral normalization convolutional network to verify sample rationality. The improved Isolation Forest model introduces a feature importance weighting mechanism to optimize a tree structure splitting criterion, improving detection sensitivity to hidden faults. Pre-screening results are stored in a priority event pool, triggering a real-time training task of the hierarchical early warning model.

The spatio-temporal fusion Transformer of the hierarchical early warning model construction module adopts a multi-head self-attention layer to capture spatio-temporal dependence of voltage sequences, and outputs a device-level fault heat map. The reinforcement learning framework combines a proximal policy optimization algorithm to generate a scheduling strategy with load balance degree and energy storage life loss as constraints. The transfer learning module uses model parameters pre-trained on a historical power grid as an initialization benchmark, aligns feature distributions between old and new scenarios through domain adversarial training, and shortens a strategy convergence cycle.

The fuzzy inference engine of the risk assessment and decision-making module maps device fault probability and system strategy scores into a comprehensive risk index, and triggers a hierarchical response mechanism. The digital twin platform constructs the virtual mirror image of the power supply network, injects real-time topological parameters to simulate an influence of a load transfer strategy on line loss, and outputs an optimal execution path. A blockchain smart contract performs hash digest calculation and multi-signature on scheduling instructions, generating a tamper-proof audit traceability chain.

The meta-learning framework of the closed-loop optimization module analyzes characteristics of multi-batch prediction deviations, and dynamically adjusts feature selection weights and model hyperparameter configurations. The elastic weight consolidation algorithm calculates the Fisher information matrix of model parameters with respect to historical tasks, and constrains the weight update amplitude in the incremental learning process. The model distillation module adopts the temperature scaling strategy to transfer knowledge of the spatio-temporal fusion Transformer to the lightweight TinyLSTM network, adapting to real-time inference requirements of edge nodes. Optimized model parameters are deployed in stages through a canary release mechanism to maintain continuity of system services.

Data flows among all modules form a closed-loop control link: raw data collected by the sensor network is transmitted to the multi-source data fusion module after being processed by the edge computing node; cross-domain features extracted by the federated learning drive dynamic feature engineering and abnormality detection; the output of the hierarchical early warning model guides risk assessment and decision-making; execution instructions encapsulated by the blockchain are fed back to the digital twin platform for effect verification; the closed-loop optimization module iteratively updates model parameters and feature generation strategies according to the verification results. Collaboration between the federated learning and the knowledge graph realizes feature fusion under privacy protection; coordination between the adversarial training and the model distillation balances detection accuracy and inference efficiency; and combination of the transfer learning and the reinforcement learning accelerates the strategy optimization process. The overall architecture meets technical requirements for intelligent monitoring and energy storage scheduling of the power system.

Specific implementations of the present disclosure in the technical field of circuit devices for power supply or distribution and electric energy storage systems are as follows. A distributed sensor network is deployed at transformers, section switch nodes of a power distribution network, and battery cluster monitoring points of an energy storage system, and includes Hall current sensors, voltage transformers, and temperature sensors. Sensor nodes transmit data through a low-power wide-area network protocol, with a sampling frequency set to 1 kHz. A sliding window filtering algorithm is adopted for voltage and current signals to eliminate high-frequency noise, and a window length is adaptively adjusted according to a load fluctuation period. An edge computing node incorporates an interquartile range outlier detection module, performs linear interpolation compensation and standardized processing on raw data, generates an intermediate data stream in JSON format, attaches a timestamp and a device geographic tag, and pushes the intermediate data stream to a cloud message queue through an MQTT protocol.

A multi-source data fusion module adopts a hierarchical federated learning framework, establishes an encrypted communication channel between a SCADA system and a smart meter data source, realizes cross-domain gradient sharing through a Paillier homomorphic encryption algorithm, and extracts node vulnerability feature vectors of power distribution network topological nodes in combination with a graph embedding algorithm, with a dimension set to 128 dimensions. A knowledge graph construction module applies a GraphSAGE algorithm to aggregate neighborhood node attributes, generates a topological relation matrix characterizing regional power supply correlation strength, and performs tensor fusion with a charge-discharge-load dynamic correlation matrix calculated by a spatio-temporal attention mechanism to construct a power operation knowledge graph.

In a dynamic feature engineering module, a wavelet transform unit adopts a DB4 wavelet basis to perform 5-layer decomposition on voltage harmonic data, and extracts energy entropy of each sub-band as a harmonic distortion feature. A generator of a generative adversarial network generates adversarial samples injected with simulated sensor noise based on device type tags, and a discriminator adopts a spectral normalization convolutional network to verify sample rationality. An improved Isolation Forest model introduces information gain to optimize a feature splitting criterion, with a tree number set to 100. Events with abnormal scores higher than a dynamic threshold are screened and stored in a priority event pool.

In a hierarchical early warning model construction module, a spatio-temporal fusion Transformer architecture adopts a 4-head self-attention layer with an input sequence length of 60 time steps, and outputs a device-level fault heat map. A hybrid reinforcement learning framework takes a load balance degree threshold of ±5% and an energy storage life attenuation rate ≤ 0.1%/cycle as constraints, and generates a charge-discharge scheduling strategy through a proximal policy optimization algorithm. A transfer learning module pre-trains strategy network parameters by using historical power grid data, aligns feature distribution differences by adopting domain adversarial training, and sets a learning rate in a fine-tuning stage to 1e-4.

In a risk assessment and decision‑making module, a fuzzy Petri net model maps device fault probability into a comprehensive risk index within an interval [0, 1], simulates the influence of a load transfer strategy on line loss in combination with a digital twin platform with a simulation step size set to 1 second, and outputs an optimal execution path. A blockchain smart contract performs SHA‑256 hash calculation on scheduling instructions, adopts a multi‑signature mechanism to verify instruction integrity, and generates a tamper‑proof audit traceability chain.

A closed‑loop optimization module calculates a Fisher information matrix of model parameters through an elastic weight consolidation algorithm, and constrains a weight update amplitude in an incremental learning process with a regularization coefficient set to 0.5. A model distillation module adopts a temperature parameter T=2 to smooth an output distribution of the spatio‑temporal fusion Transformer, and transfers knowledge to a lightweight TinyLSTM network with a compressed layer number of 3, adapting to real‑time inference requirements of the edge computing node. Data flows among all modules are transmitted asynchronously through a Kafka message queue to ensure high‑concurrency processing capability of the system.

Explanation of technical feature terms of the present disclosure is as follows:

Distributed sensor network:
A collection of sensors deployed at key nodes of a power supply network (such as power distribution transformers and line section switches) and monitoring points of an energy storage system, including voltage transformers, Hall current sensors, temperature sensors and the like. Real-time collection of parameters such as voltage, current, load fluctuation data and charge-discharge efficiency and capacity attenuation rate of the energy storage system is performed through a low-power wide-area network protocol (such as LoRaWAN) to generate a raw data stream.
Function: providing a data source with high precision and strong real-time performance for subsequent analysis, covering multi-dimensional information of a physical layer and operation state of a power system.

Edge computing node:
A local computing unit deployed at a data collection end, responsible for performing preliminary processing on raw data, including data cleaning (such as sliding window filtering to eliminate noise), outlier detection (based on an interquartile range algorithm), missing value compensation (linear interpolation or Kalman filtering) and standardization (normalizing data to an interval [-1,1]).
Function: reducing cloud transmission pressure, improving data quality, and providing structured input (such as standardized intermediate data in JSON format) for subsequent analysis.

Federated learning framework: a distributed machine learning technology that allows multiple participants (such as a SCADA system and a smart meter) to collaboratively train a model without sharing raw data. In the present disclosure, a hierarchical federated learning architecture is adopted, and cross-domain data alignment and feature sharing are realized through differential privacy technology (adding Laplace noise) and a Paillier homomorphic encryption algorithm (encrypted gradient transmission).

Function: integrating structured monitoring data of a SCADA system and unstructured load curves of a smart meter on the premise of protecting data privacy of each subsystem to extract cross-domain correlated features.

Knowledge graph technology: a graph-structure-based data representation method for constructing a power operation knowledge graph. Node vulnerability features (such as electrical load rate and power supply radius) of power distribution network topological nodes are extracted through a graph embedding algorithm (such as GraphSAGE), and dynamic correlation between charge-discharge efficiency and load fluctuations is captured by using a spatio-temporal attention mechanism.

Function: forming a multi-dimensional semantic network containing device states, load correlation patterns and energy storage response characteristics, and enhancing the correlation analysis capability of cross-modal data.

Self-supervised learning: a machine learning method that generates supervision signals through a structure of data itself without manual labeling of tags. In the present disclosure, it is used for dynamic feature engineering processing, for example, extracting harmonic distortion features from non-stationary time-series data through wavelet transform, or generating abnormal samples through a generative adversarial network (GAN) to enhance data distribution.

Function: improving the identification sensitivity of an abnormality detection model to hidden faults and solving the problem of sample imbalance.

Spatio-temporal fusion Transformer architecture: a deep learning model combining time series and spatial dependence. A multi-head self-attention mechanism is adopted to model the spatio-temporal correlation of voltage and current sequences (such as the influence of device-level voltage fluctuation on adjacent nodes), and an interpretability module (such as SHAP values) is used to locate the contribution degree of abnormal features.

Function: accurately predicting device-level fault probability (such as transformer overload risk) and generating a visual diagnosis report.

Hybrid reinforcement learning framework: combining a deep deterministic policy gradient (DDPG) algorithm and a proximal policy optimization (PPO) algorithm, with load balance degree and energy storage life loss as constraint conditions, to optimize the load distribution and energy storage scheduling strategy of a power distribution network. A transfer learning module is used to pre-train a strategy network to accelerate the convergence of the strategy in new scenarios.

Function: realizing system-level risk prevention and control (such as avoiding line overload) and medium- and long-term economic optimization (such as prolonging energy storage life).

Model distillation technology: transferring the knowledge of a complex model (such as a spatio-temporal fusion Transformer) to a lightweight network (such as TinyLSTM). A temperature scaling strategy is adopted to soften output probability distribution, and a KL divergence loss function is used to align the decision logic of a teacher model and a student model.

Function: compressing model scale to adapt to the low-latency reasoning requirement of edge devices while maintaining detection accuracy.

Meta-learning framework: a mechanism of “learning how to learn”, which dynamically adjusts feature weights and model hyper-parameters by analyzing the statistical characteristics of multi-batch prediction deviations. It is combined with an elastic weight consolidation (EWC) algorithm to prevent the forgetting of historical knowledge in incremental learning.

Function: realizing adaptive iteration of an early warning model to adapt to a dynamic operation environment of a power system.

Digital twin platform: constructing a virtual mirror image of a power supply network based on real-time topological data, and simulating the influence of different scheduling strategies (such as load transfer schemes) on line loss and voltage stability through a discrete event simulation engine.

Function: verifying the feasibility of strategies, outputting an optimal execution path, and realizing tamper-proof instruction traceability in combination with blockchain technology.

Federated learning framework: realizing secure fusion of cross-domain data, and integrating multi-source heterogeneous data on the premise of protecting data privacy of each subsystem (such as a SCADA system and a smart meter).

Implementation mode: hierarchical federated architecture: each participant (power subsystem) trains a model locally, and a central server aggregates encrypted gradients to generate a global model.

Privacy protection technologies:
Differential privacy: adding Laplace noise to model gradients to prevent raw data leakage.

Paillier homomorphic encryption: performing encrypted transmission on gradients to ensure the security of a cross-domain sharing process.

Application: aligning structured monitoring data of a SCADA system with unstructured load curves of a smart meter to generate cross-domain correlated features, supporting the subsequent construction of a knowledge graph.

Knowledge graph technology: constructing a power operation knowledge graph to characterize device states, topological relations and dynamic behavior correlations.

Implementation mode: Graph embedding algorithm (GraphSAGE):
performing unsupervised learning on a power distribution network topology to extract node vulnerability features (such as electrical load rate and power supply radius).

Spatio-temporal attention mechanism: calculating a dynamic correlation matrix of a charge-discharge efficiency sequence and a load fluctuation curve to identify a risk propagation path.

Application: generating a multi-dimensional semantic network containing health state of power supply devices and regional load correlation patterns, providing a correlation basis for abnormality detection and risk assessment.

Self-supervised learning: automatically extracting features from unlabeled data to solve the problem of scarce abnormal samples.

Implementation mode: Wavelet transform:
performing multi-resolution decomposition on non-stationary time-series data (such as voltage harmonics) to extract energy entropy of each frequency band as a harmonic distortion feature.

Generative adversarial network (GAN):
Generator: simulating sensor noise to generate diverse abnormal samples.
Discriminator: focusing on classification training of high-risk samples through a Focal Loss function.
Application: enhancing the data distribution of an abnormality detection model and improving the identification sensitivity to hidden faults (such as partial discharge).

Spatio-temporal fusion Transformer architecture:
modeling spatio-temporal dependence of time-series data of a power supply network to accurately locate device-level faults.

Implementation mode: Multi-head self-attention mechanism: capturing spatio-temporal correlation of voltage and current sequences (such as the influence of a node overload on adjacent lines).

Interpretability module (SHAP values): calculating the contribution degree of each feature to an abnormal score and generating a visual diagnosis report.

Application: outputting a device-level fault heat map (such as the probability of transformer insulation aging) to assist operation and maintenance personnel in quickly locating a source of an abnormality.

Hybrid reinforcement learning framework: optimizing a load distribution and energy storage scheduling strategy of a power distribution network to balance power supply reliability and economic efficiency.

Implementation mode:
Deep deterministic policy gradient (DDPG): generating a continuous action space strategy with load balance degree and energy storage life loss as constraint conditions.

Proximal policy optimization (PPO): dynamically adjusting charge-discharge power thresholds through trust region constraints to ensure strategy stability.

Transfer learning module: pre-training a strategy network by using historical power grid data to accelerate the convergence of the strategy in new scenarios.

Application: generating an optimal load transfer scheme (such as switching a standby line) and an energy storage scheduling instruction (such as charge-discharge power adjustment) to avoid system-level risks (such as cascading faults).

Model distillation technology: compressing the scale of a complex model to adapt to edge computing resources.

Implementation mode:
Temperature scaling: softening an output probability distribution of a spatio-temporal fusion Transformer to generate soft target tags.

KL divergence loss function: aligning decision logic of a teacher model and a student model (complex model and lightweight TinyLSTM).

Application: deploying a device-level fault prediction model at an edge node to realize low-latency real-time reasoning (such as millisecond-level abnormality detection).

Meta-learning framework: dynamically optimizing model parameters and feature weights to adapt to a dynamic operation environment of a power system.

Implementation mode:
Elastic weight consolidation algorithm (EWC): calculating a Fisher information matrix of model parameters for historical tasks, restricting weight update amplitude in incremental learning, and preventing knowledge forgetting.

Deviation analysis module: statistically analyzing the characteristics of multi-batch prediction errors and dynamically adjusting feature selection weights (such as the priority of harmonic distortion features).

Application: realizing adaptive iteration (such as periodic update) of an early warning model and improving the generalization capability to new fault patterns (such as new energy grid-connected disturbance).

Digital twin platform: simulating the execution effect of strategies and verifying the feasibility of scheduling instructions.

Implementation mode:
Discrete event simulation engine: constructing a virtual mirror image based on real-time topological data to simulate the influence of load transfer on line loss and voltage stability.

Blockchain traceability mechanism: performing hash digest calculation on simulation results and optimization strategies to generate a tamper-proof audit traceability chain.

Application: outputting an optimal execution path (such as stage-by-stage load switching) and realizing credible execution of instructions through a smart contract.

The present disclosure realizes efficient data collection and preprocessing through the distributed sensor network and edge computing, fuses multi-source heterogeneous data by using federated learning and knowledge graph technology, improves the accuracy of abnormality detection by combining self-supervised learning and the spatio-temporal fusion Transformer, optimizes the system-level scheduling strategy through hybrid reinforcement learning, and realizes model lightweighting and adaptive iteration by model distillation and meta-learning. The collaborative effect of all technical features finally achieves the comprehensive improvement of the real-time performance of abnormality detection, the accuracy of risk assessment and the economic efficiency of energy storage scheduling of the power system.

The technical solutions of the present disclosure effectively solve the problem of delayed abnormality detection caused by the dependence of traditional power systems on static thresholds through the dynamic feature engineering and incremental learning mechanism. The wavelet transform is adopted to extract harmonic distortion features from non-stationary time-series data, the generative adversarial network is combined to enhance the diversity distribution of abnormal samples, and optimizes the sensitivity of the lightweight abnormality detection model; self-supervised learning dynamically adjusts feature weights, and the meta-learning framework is combined to analyze prediction deviations, forming a feature generation strategy adaptive to the change of the operation state of the power system and improving the capability of identifying hidden faults under complex working conditions.

Aiming at the problems of insufficient utilization of multi-source data and privacy protection, the multi-source data fusion module integrates heterogeneous data of the SCADA system, the smart meters and the energy storage BMS through the federated learning framework, and realizes cross-domain gradient sharing by adopting differential privacy and homomorphic encryption technologies. The knowledge graph technology fuses node vulnerability features of the topology and the dynamic correlation matrix generated by the spatio-temporal attention mechanism to construct the multi-dimensional knowledge graph containing the health state of devices, load correlation patterns and energy storage response characteristics, which enhances the semantic correlation analysis capability of cross-modal data and solves the one-sidedness problem of traditional single data source analysis.

To optimize the efficiency of system-level risk prevention and control, the hierarchical early warning model adopts the spatio-temporal fusion Transformer architecture to capture spatio-temporal dependence of voltage and current sequences and accurately locate the root cause of device-level abnormalities; the reinforcement learning framework combines transfer learning pre-training strategies to dynamically optimize the load distribution of the power distribution network and energy storage scheduling actions, and simulates the strategy execution effect through the digital twin platform. The closed-loop optimization module restricts parameter updates in incremental learning through the elastic weight consolidation algorithm, compresses the scale of complex models in combination with the model distillation technology to adapt to edge computing resources, realizes efficient iteration of the early warning model and real-time reasoning at the edge end, and ultimately improves the abnormal response speed of the power supply network and the economic efficiency of energy storage scheduling.

What is claimed is:

1. An audit data early warning method, comprising:
Step S101: collecting node voltage, current and load fluctuation data of a power supply network, and charge-discharge efficiency and capacity attenuation rate data of an electric energy storage system to generate a raw data stream;
Step S102: inputting the raw data stream into an edge computing node to perform local cleaning and standardized format conversion, to generate standardized intermediate data;
Step S103: performing cross-domain data fusion on the standardized intermediate data based on a federated learning framework and knowledge graph technology, extracting hidden features of topological relations of a power distribution network and dynamic correlation features between its charge-discharge behaviors and load fluctuations, and generating a correlation feature vector;
said Step S103 comprises: extracting node vulnerability features in the topological relations of the power distribution network through a graph embedding algorithm, and capturing a nonlinear correlation between charge-discharge efficiency and load fluctuations based on a spatio-temporal attention mechanism; through differential privacy technology and a Paillier homomorphic encryption algorithm, performing federated learning alignment on structured data of a SCADA system and unstructured data of smart meters to generate a cross-domain correlated power operation knowledge graph containing device states, load distribution and topological relations; and taking the hidden features and the dynamic correlation features as input to a dynamic feature engineering module, and forming a data closed loop for abnormal pattern pre-screening with an output of an abnormality detection model;
Step S104: performing dynamic feature engineering processing on the correlation feature vector by using self-supervised learning to generate multi-dimensional operation state features of a power system, performing abnormal pattern pre-screening on high-dimensional features through a lightweight abnormality detection model, and outputting a high-risk event pool;
Step S105: constructing a hierarchical early warning model based on the high-risk event pool, performing spatio-temporal feature modeling on time-series data of the power supply network by adopting a spatio-temporal fusion Transformer architecture to predict a device-level fault probability, and optimizing a load distribution and energy storage scheduling strategy of the power distribution network through a hybrid reinforcement learning framework to predict a system-level risk;
Step S106: generating a dynamic risk assessment level by combining fuzzy logic reasoning and evidence theory according to the device-level fault probability and a system-level risk prediction result, and triggering a real-time alarm or generating an energy storage scheduling suggestion and a load transfer scheme; and
Step S107: collecting system response data after execution of an early warning strategy, analyzing model prediction deviations through a meta-learning framework, and dynamically adjusting feature weights and a model structure to form a closed-loop optimization link;
wherein the raw data stream is transmitted to a data fusion module after being processed by the edge computing node, the correlation feature vector is input into the dynamic feature engineering module to generate a pre-screening result, the high-risk event pool drives training and decision-making of the hierarchical early warning model, and the risk assessment result is fed back reversely to a model optimization module.

2. The audit data early warning method according to claim 1, wherein said Step S104 comprises:
extracting harmonic distortion features from non-stationary time-series data by adopting wavelet transform, and performing data augmentation on abnormal samples through a generative adversarial network;
inputting augmented features into an improved Isolation Forest algorithm to perform rapid abnormality detection, and storing screened high-risk events into an event pool; and
taking the event pool as input to the hierarchical early warning model, and forming collaborative analysis of device-level and system-level risk assessment with spatio-temporal feature modeling of a spatio-temporal fusion Transformer.

3. The audit data early warning method according to claim 2, wherein said Step S105 comprises:
introducing an interpretability module into a primary model, and locating a contribution degree of an abnormal feature through a SHAP value to assist in generating a device-level alarm instruction;
embedding a transfer learning module into a secondary model, and pre-training a strategy network by using historical power grid data to accelerate convergence of a load distribution strategy in new scenarios; and
inputting an output of the primary model and a strategy optimization result of the secondary model into a risk assessment module together to realize linkage of short-term fault response and medium-and long-term risk prevention and control.

4. The audit data early warning method according to claim 3, wherein said Step S106 comprises:
adjusting an early warning threshold according to a real-time load state by adopting a sliding window statistical method, and simulating execution effect of the energy storage scheduling strategy in combination with a digital twin platform;
balancing power supply reliability and economic efficiency through a multi-objective optimization algorithm, generating the load transfer scheme, and pushing the load transfer scheme to an operation and maintenance terminal; and
taking a result of the simulation and an optimization strategy as input to an early warning execution module, and forming a tamper-proof instruction transmission link with a blockchain traceability mechanism.

5. The audit data early warning method according to claim 4, wherein said Step S107 comprises:
constraining update of model weights in an incremental learning process through an elastic weight consolidation algorithm to prevent forgetting of historical knowledge;
transferring knowledge of a complex hybrid model to a lightweight network by using model distillation technology to adapt to real-time reasoning requirement of edge devices; and
inputting reversely the update of the model weights and a result of knowledge transfer into the feature engineering module to drive iterative optimization of dynamic feature generation and abnormality detection.

6. The audit data early warning method according to claim 5, wherein said performing federated learning alignment on structured data of a SCADA system and unstructured data of smart meters to generate a cross-domain correlated power operation knowledge graph comprises:
adopting the differential privacy technology to protect data security of each power subsystem in a data fusion process, and realizing cross-domain feature sharing through gradient encrypted transmission; and
inputting topological relation features of the knowledge graph and data after the federated learning alignment into the spatio-temporal attention mechanism together to enhance robustness of correlation analysis between the charge-discharge behaviors and the load fluctuations.

7. The audit data early warning method according to claim 6, wherein said performing data augmentation on abnormal samples through a generative adversarial network comprises a generator and a discriminator, and wherein the generator is configured to inject adversarial perturbations simulating sensor noise into input data, and the discriminator focuses on classification training of high-risk samples through a Focal Loss function;
injecting the adversarial perturbations simulating sensor noise into the input data, and focusing on the classification training of high-risk samples through the Focal Loss function; and
forming a high-precision pre-screening result by a feature vector after adversarial training and an output of the lightweight abnormality detection model to reduce a false alarm rate of the hierarchical early warning model.

8. The audit data early warning method according to claim 7, wherein said embedding a transfer learning module into a secondary model, and pre-training a strategy network by using historical power grid data to accelerate convergence of a load distribution strategy in new scenarios comprises:
initializing reinforcement learning network parameters by using a pre-trained power distribution network load distribution strategy, and dynamically adjusting energy storage scheduling actions through a proximal policy optimization algorithm; and
driving strategy simulation of the digital twin platform by a collaborative output of transfer learning and reinforcement learning to form a closed-loop verification link from model training to actual execution.

9. An audit data early warning system applied to the audit data early warning method according to claim 1, comprising:
a distributed sensor network configured to collect in real time node voltage and current of the power supply network and charge-discharge efficiency data of the electric energy storage system;
an edge computing node connected with the sensor network and configured to perform local cleaning and standardized processing on raw data to generate the standardized intermediate data;
a multi-source data fusion module connected with the edge computing node and configured to extract cross-domain correlated features through federated learning and knowledge graph technology;
a dynamic feature engineering module connected with the multi-source data fusion module and configured to generate the multi-dimensional operation state features and perform the abnormal pattern pre-screening;
a hierarchical early warning model construction module connected with the dynamic feature engineering module and configured to train the spatio-temporal fusion Transformer and the hybrid reinforcement learning framework;
a risk assessment and decision-making module connected with the hierarchical early warning model construction module and configured to generate a dynamic risk level and the energy storage scheduling strategy; and
a closed-loop optimization module connected with the risk assessment and decision-making module and configured to realize adaptive updating of the early warning model through meta-learning and model distillation technology;
wherein data of the sensor network is transmitted to the edge computing node, the
standardized intermediate data is input to the dynamic feature engineering module after being processed by the multi-source data fusion module, an output of the hierarchical early warning model drives risk assessment and decision-making, and a decision-making result is fed back reversely to the closed-loop optimization module.
